(19) United States
(12) Patent Application Publication
(10) Pub. No.: US 2002/0191032 A1
(43) Pub. Date: Dec. 19, 2002

(54) Method and apparatus for viewing and managing information in a history

(75) Inventors: Michael Wayne Brown, Georgetown, TX (US); Michael Aaron Kaply, Austin, TX (US); Aaron Keith Reed, Austin, TX (US); Cristi Nesbitt Ullmann, Austin, TX (US)

Correspondence Address: Duke W. Yee, Carstens, Yee & Cahoon, LLP, P.O. Box 802334, Dallas, TX, 75380, US

(73) Assignee: International Business Machines Corporation, Armonk, NY

(21) Appl. No.: 09/884,491

(22) Filed: Jun. 18, 2001

(51) Int. Cl. G06F 3/00

(52) U.S. Cl. 345/838

(57) ABSTRACT

A method and apparatus for managing confidential information in a graphical user interface in a data processing system. Confidential information is generated within a history generated by a browser in the graphical user interface to form a presentation. A user input is received. The confidential information is manipulated using the user input.

### CROSS REFERENCE TO RELATED APPLICATIONS

The present invention is related to Method and Apparatus for Removing Confidential Information from a History, Ser. No. 09/______, attorney docket no. AUS920010544US1 and Method and Apparatus for Removing Information from a Server, Ser. No. 09/______, attorney docket no. AUS920010546US1, filed even date hereof, assigned to the same assignee, and incorporated herein by reference.

### BACKGROUND OF THE INVENTION

1. Technical Field

The present invention relates generally to an improved data processing system, and in particular to a method and apparatus for managing data. Still more particularly, the present invention provides a method, apparatus, and computer implemented instructions for viewing and managing in a history generated by a browser.

2. Description of Related Art

The Internet, also referred to as an “internetwork”, is a set of computer networks, possibly dissimilar, joined together by means of gateways that handle data transfer and the conversion of messages from protocols of the sending network to the protocols used by the receiving network (with packets if necessary). When capitalized, the term “Internet” refers to the collection of networks and gateways that use the TCP/IP suite of protocols.

The Internet has become a cultural fixture as a source of both information and entertainment. Many businesses are creating Internet sites as an integral part of their marketing efforts, informing consumers of the products or services offered by the business or providing other information seeking to engender brand loyalty. Many federal, state, and local government agencies are also employing Internet sites for informational purposes, particularly agencies, which must interact with virtually all segments of society such as the Internal Revenue Service and secretaries of state. Providing informational guides and/or searchable databases of online public records may reduce operating costs. Further, the Internet is becoming increasingly popular as a medium for commercial transactions.

Currently, the most commonly employed method of transferring data over the Internet is to employ the World Wide Web environment, also called simply “the Web”. Other Internet resources exist for transferring information, such as File Transfer Protocol (FTP) and Gopher, but have not achieved the popularity of the Web. In the Web environment, servers and clients affect data transaction using the Hypertext Transfer Protocol (HTTP), a known protocol for handling the transfer of various data files (e.g., text, still graphic images, audio, motion video, etc.). The information in various data files is formatted for presentation to a user by a standard page description language, the Hypertext Markup Language (HTML). In addition to basic presentation formatting, HTML allows developers to specify “links” to other Web resources identified by a Uniform Resource Locator (URL). A URL is a special syntax identifier defining a communications path to specific information. A URL identifies each logical block of information accessible to a client, called a “page” or a “Web page”. The URL provides a universal, consistent method for finding and accessing this information, not necessarily for the user, but mostly for the user's Web “browser”. A browser is a program capable of submitting a request for information identified by an identifier, such as, for example, a URL. A user may enter a domain name through a graphical user interface (GUI) for the browser to access a source of content. The domain name is automatically converted to the Internet Protocol (IP) address by a domain name system (DNS), which is a service that translates the symbolic name entered by the user into an IP address by looking up the domain name in a database.

There are a number of ways to find out what Web pages have been viewed in a browser. For example, a disk cache is present in which various files, such as graphic images, are stored with respect to a Web page. Additionally, a history list is often recorded to identify URLs that have been visited by a user. Also, a location list containing URLs entered by the user is present. Other types of disk caches include cookies for various Web sites, which are stored in a cookie file for the browser. This recorded information is an example of a history that may be recorded for a Web page received by a user or a Web site visited by the user. These histories also may contain confidential or personal information.

In some instances, a user may desire to prevent others from identifying confidential or personal information that may be located in history. Currently, a user is required to go back through the history and locate the Web pages or cookies that may contain the confidential or personal information and delete the information from the history. The procedure would include, for example, identifying and deleting files in a disk cache and deleting cookies in a cookie file. Searching various files or other data structures for confidential or personal information is often difficult and may require the use of multiple applications. Such a procedure is tedious and often difficult for many users.

Therefore, it would be advantageous to have an improved method and apparatus for identifying and removing confidential or personal information from a history.

### SUMMARY OF THE INVENTION

The present invention provides for a method and apparatus for managing confidential information in a graphical user interface in a data processing system. Confidential information is generated within a history generated by a browser in the graphical user interface to form a presentation. A user input is received. The confidential information is manipulated using the user input.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 is a pictorial representation of a data processing system in which the present invention may be implemented in accordance with a preferred embodiment of the present invention;

FIG. 2 is a block diagram of a data processing system in which the present invention may be implemented;

FIG. 3 is a diagram illustrating components used in disabling recording of a history in accordance with a preferred embodiment of the present invention;

FIG. 4 is a block diagram of a browser program in accordance with a preferred embodiment of the present invention;

FIG. 5 is a diagram of graphical user interface for defining privacy preferences in accordance with a preferred embodiment of the present invention;

FIG. 6 is a diagram of a input window in accordance with a preferred embodiment of the present invention;

FIG. 7 is a diagram of a preview of Web pages in accordance with a preferred embodiment of the present invention;

FIG. 8 is a diagram of a Web page presented in a window in accordance with a preferred embodiment of the present invention;

FIG. 9 is a flowchart of a process used for removing information from a history in accordance with a preferred embodiment of the present invention;

FIG. 10 is a flowchart of a process used for defining information for removal in accordance with a preferred embodiment of the present invention;

FIG. 11 is a flowchart of a process used for defining information for removal in accordance with a preferred embodiment of the present invention; and

FIG. 12 is a flowchart of a process used for previewing Web pages containing confidential information in accordance with a preferred embodiment of the present invention.

### DETAILED DESCRIPTION OF THE PREFERRED EMBODIMENT

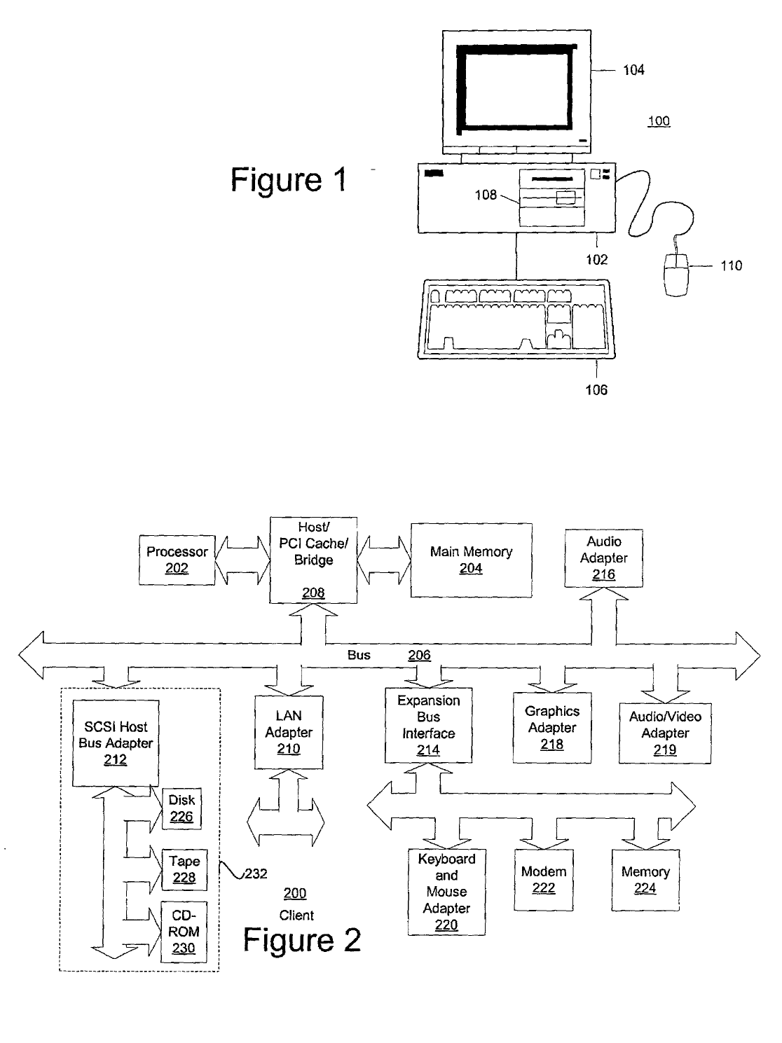

With reference now to the figures and in particular with reference to FIG. 1, a pictorial representation of a data processing system in which the present invention may be implemented is depicted in accordance with a preferred embodiment of the present invention. A computer 100 is depicted which includes a system unit 102, video display terminal 104, keyboard 106, storage devices 108, which may include floppy drives and other types of permanent and removable storage media, and mouse 110. Additional input devices may be included with personal computer 100, such as, for example, a joystick, touchpad, touch screen, trackball, microphone, and the like. Computer 100 can be implemented using any suitable computer, such as an IBM RS/6000 computer or IntelliStation computer, which are products of International Business Machines Corporation, located in Armonk, N.Y. Although the depicted representation shows a computer, other embodiments of the present invention may be implemented in other types of data processing systems, such as a network computer. Computer 100 also preferably includes a graphical user interface that may be implemented by means of systems software residing in computer readable media in operation within computer 100.

With reference now to FIG. 2, a block diagram of a data processing system is shown in which the present invention may be implemented. Data processing system 200 is an example of a computer, such as computer 100 in FIG. 1, in which code or instructions implementing the processes of the present invention may be located. Data processing system 200 employs a peripheral component interconnect (PCI) local bus architecture. Although the depicted example employs a PCI bus, other bus architectures such as Accelerated Graphics Port (AGP) and Industry Standard Architecture (ISA) may be used. Processor 202 and main memory 204 are connected to PCI local bus 206 through PCI bridge 208. PCI bridge 208 also may include an integrated memory controller and cache memory for processor 202. Additional connections to PCI local bus 206 may be made through direct component interconnection or through add-in boards. In the depicted example, local area network (LAN) adapter 210, small computer system interface (SCSI) host bus adapter 212, and expansion bus interface 214 are connected to PCI local bus 206 by direct component connection. In contrast, audio adapter 216, graphics adapter 218, and audio/video adapter 219 are connected to PCI local bus 206 by add-in boards inserted into expansion slots. Expansion bus interface 214 provides a connection for a keyboard and mouse adapter 220, modem 222, and additional memory 224. SCSI host bus adapter 212 provides a connection for hard disk drive 226, tape drive 228, and CD-ROM drive 230. Typical PCI local bus implementations will support three or four PCI expansion slots or add-in connectors.

An operating system runs on processor 202 and is used to coordinate and provide control of various components within data processing system 200 in FIG. 2. The operating system may be a commercially available operating system such as Windows 2000, which is available from Microsoft Corporation. An object oriented programming system such as Java may run in conjunction with the operating system and provides calls to the operating system from Java programs or applications executing on data processing system 200. “Java” is a trademark of Sun Microsystems, Inc. Instructions for the operating system, the object-oriented programming system, and applications or programs are located on storage devices, such as hard disk drive 226, and may be loaded into main memory 204 for execution by processor 202.

Those of ordinary skill in the art will appreciate that the hardware in FIG. 2 may vary depending on the implementation. Other internal hardware or peripheral devices, such as flash ROM (or equivalent nonvolatile memory) or optical disk drives and the like, may be used in addition to or in place of the hardware depicted in FIG. 2. Also, the processes of the present invention may be applied to a multiprocessor data processing system.

For example, data processing system 200, if optionally configured as a network computer, may not include SCSI host bus adapter 212, hard disk drive 226, tape drive 228, and CD-ROM 230, as noted by dotted line 232 in FIG. 2 denoting optional inclusion. In that case, the computer, to be properly called a client computer, must include some type of network communication interface, such as LAN adapter 210, modem 222, or the like. As another example, data processing system 200 may be a stand-alone system configured to be bootable without relying on some type of network communication interface, whether or not data processing system 200 comprises some type of network communication interface. As a further example, data processing system 200 may be a personal digital assistant (PDA), which is configured with ROM and/or flash ROM to provide nonvolatile memory for storing operating system files and/or user-generated data.

The depicted example in FIG. 2 and above-described examples are not meant to imply architectural limitations. For example, data processing system 200 also may be a notebook computer or hand held computer in addition to taking the form of a PDA. Data processing system 200 also may be a kiosk or a Web appliance. The processes of the present invention are performed by processor 202 using computer implemented instructions, which may be located in a memory such as, for example, main memory 204, memory 224, or in one or more peripheral devices 226-230.

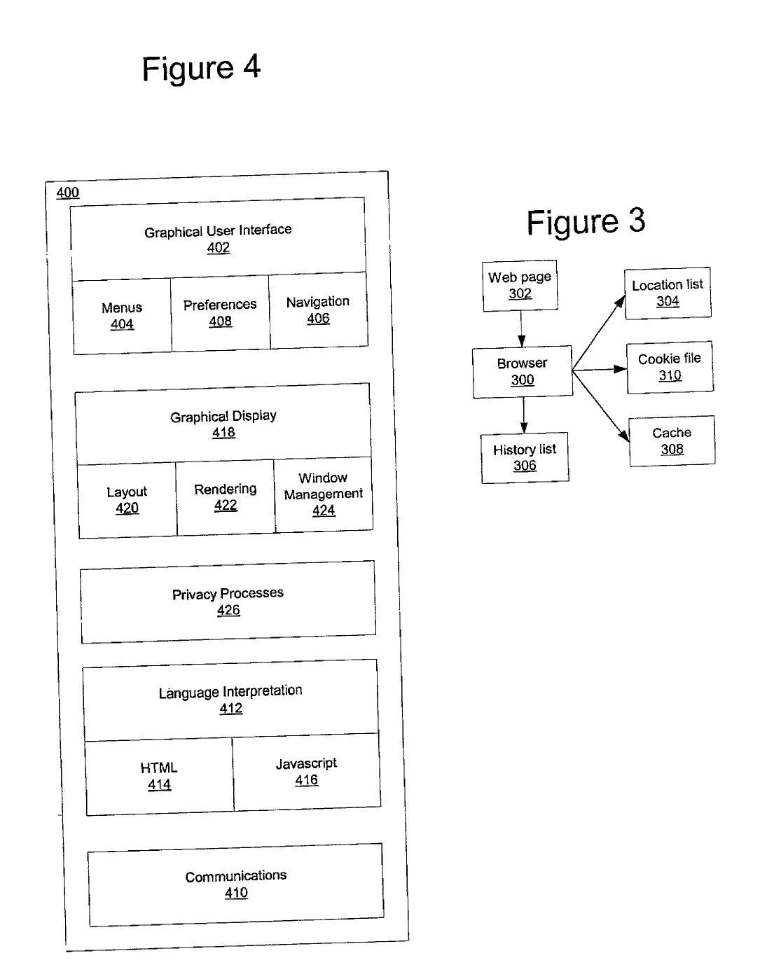

With reference now to FIG. 3, a diagram illustrating components used in disabling recording of a history is depicted in accordance with a preferred embodiment of the present invention. Browser 300 is an example of a browser, which may be executing on data processing system 200 in FIG. 2.

In this example, browser 300 receives Web page 302 for presentation. Web page 302 may be obtained by entering a URL. This URL may be stored in location list 304. Location list 304 contains URLs entered by the user. These URLs are typically entered through a field, which is often called an “address bar”. Additionally, the URL may be stored in history list 306. Further, history list 306 stores URLs to Web sites visited by the user by other means, such as a selection of a link. History list 306 also may contain a record of the date and time a Web page was visited by the user.

Cache 308 provides for temporary storage of Web pages received by the browser. For example, images and text for Web page 302 may be stored in cache 308. Cache 308 provides a quick way to redisplay Web page 302 if the user later returns to Web page 302. Another storage of information that may be used to trace or identify Web pages visited by a user is cookie file 310. A hidden data field, which may be included in the HTTP header of an HTML file, is a “cookie” data field. A cookie is an HTTP protocol header document element, which may be used to provide multiple data elements to the browser. Some Web sites may not function properly when the acceptance of cookies is disabled by the browser. Therefore, a user may not be able to access a Web site without having cookies accepted by the browser.

The information collected and stored by browser 300 are examples of data that form a history. The present invention provides a method, apparatus, and computer implemented instructions for disabling or preventing recording of a history. Recording of the history is disabled by disabling the storage of the Web page in cache 308, and disabling the storage of the URL in history list 306 and location list 304. Further, storage of cookies for the Web page in cookie file 310 is prevented. The normal processes used to record this type of information may be disabled in response to a disable signal. This disable signal may be generated through various mechanisms. For example, a user may select control, such as a button, displayed on browser 300. The disable signal also may be generated using selected user Ids. For example, if a temporary user logs on to a browser, the persistent storage of history information is disabled. Alternatively, the user may set a preference to disable the recording of histories. The preferences may be, for example, to disable recording at a particular time of the day, a selected day of the week, or for a particular Web site.

This mechanism prevents other users of a data processing system from identifying Web pages and Web sites visited by a user. Such a feature is useful in the situation in which the user is purchasing a surprise gift for a spouse. Additionally, this feature is especially useful with public kiosks, where a user may want to avoid having other users identify Web sites visited by the user.

Location list 304, history list 306, cache 308, and cookie file 310 are described as locations where information forming a history may be recorded. This information also is referred to as history information. These locations and the processes associated with the locations are presented for purposes of illustration and are not meant to limit the mechanism of the present invention to disabling recording of information to these particular locations. The mechanism of the present invention may be applied to disabling any process used to record information that can be used to provide a history of a visit to a particular Web page or Web site. In disabling processes used to record or keep histories, the mechanism of the present invention, in these examples, may employ the concept of a “sandbox” where a point in time is recorded where a user decides to not keep a history. At this point, the browser keeps track of all activities that occur from that point in time. When the user closes the browser or resets this option in some way, all data relating to a history is then deleted. Another concept that may be used is not keeping track of the history at all while surfing (i.e. no caching, no history). With this implementation, some information is still retained temporarily, such as cookies, which are kept because the cookies may be used to determine what happens later in a Web site.

Turning next to FIG. 4, a block diagram of a browser program is depicted in accordance with a preferred embodiment of the present invention. A browser is an application used to navigate or view information or data in a distributed database, such as the Internet or the World Wide Web. In particular, processes may be included within browser 400 to disable recording a history.

In this example, browser 400 includes a user interface 402, which is a graphical user interface (GUI) that allows the user to interface or communicate with browser 400. This interface provides for selection of various functions through menus 404 and allows for navigation through navigation 406. For example, menu 404 may allow a user to perform various functions, such as saving a file, opening a new window, displaying a history, and entering a URL. Navigation 406 allows for a user to navigate various pages and to select web sites for viewing. For example, navigation 406 may allow a user to see a previous page or a subsequent page relative to the present page. Additionally, menu 404 may allow a user to disable history recording through the selection of a button.

Preferences such as those illustrated in FIG. 4 may be set through preferences 408. The disablement of this history recording is accomplished by setting a preference in preference 408.

Communications 410 is the mechanism with which browser 400 receives documents and other resources from a network such as the Internet. Further, communications 410 is used to send or upload documents and resources onto a network. In the depicted example, communication 410 uses HTTP. Other protocols may be used depending on the implementation. Documents that are received by browser 400 are processed by language interpretation 412, which includes HTML unit 414 and JavaScript unit 416. Language interpretation 412 will process a document for presentation on graphical display 418. In particular, HTML statements are processed by HTML unit 414 for presentation while JavaScript statements are processed by JavaScript unit 416.

Graphical display 418 includes layout unit 420, rendering unit 422, and window management 424. These units are involved in presenting Web pages to a user based on results from language interpretation 412.

Privacy processes 426 is the portion of browser 400 in which processes for defining, locating, and removing information may be implemented in accordance with a preferred embodiment of the present invention. Of course, these processes may be implemented elsewhere, such as, for example, in a plug-in or as a separate application or program.

Browser 400 is presented as an example of a browser program in which the present invention may be embodied. Browser 400 is not meant to imply architectural limitations to the present invention. Presently available browsers may include additional functions not shown or may omit functions shown in browser 400. A browser may be any application that is used to search for and display content on a distributed data processing system. Browser 400 make be implemented using know browser applications, such Netscape Navigator or Microsoft Internet Explorer. Netscape Navigator is available from Netscape Communications Corporation while Microsoft Internet Explorer is available from Microsoft Corporation.

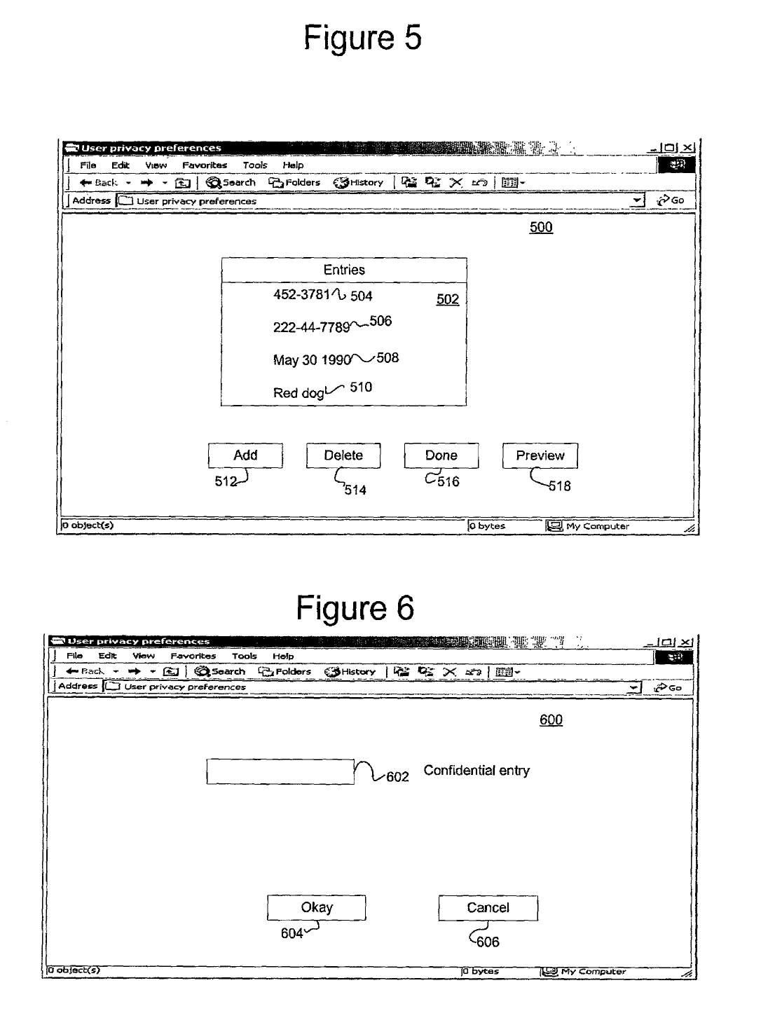

With reference now to FIG. 5, a diagram of graphical user interface for defining privacy preferences is depicted in accordance with a preferred embodiment of the present invention. Window 500 is an example of a graphical user interface (GUI), which may be used to obtain user input in pre-defining information that is to be removed from a history.

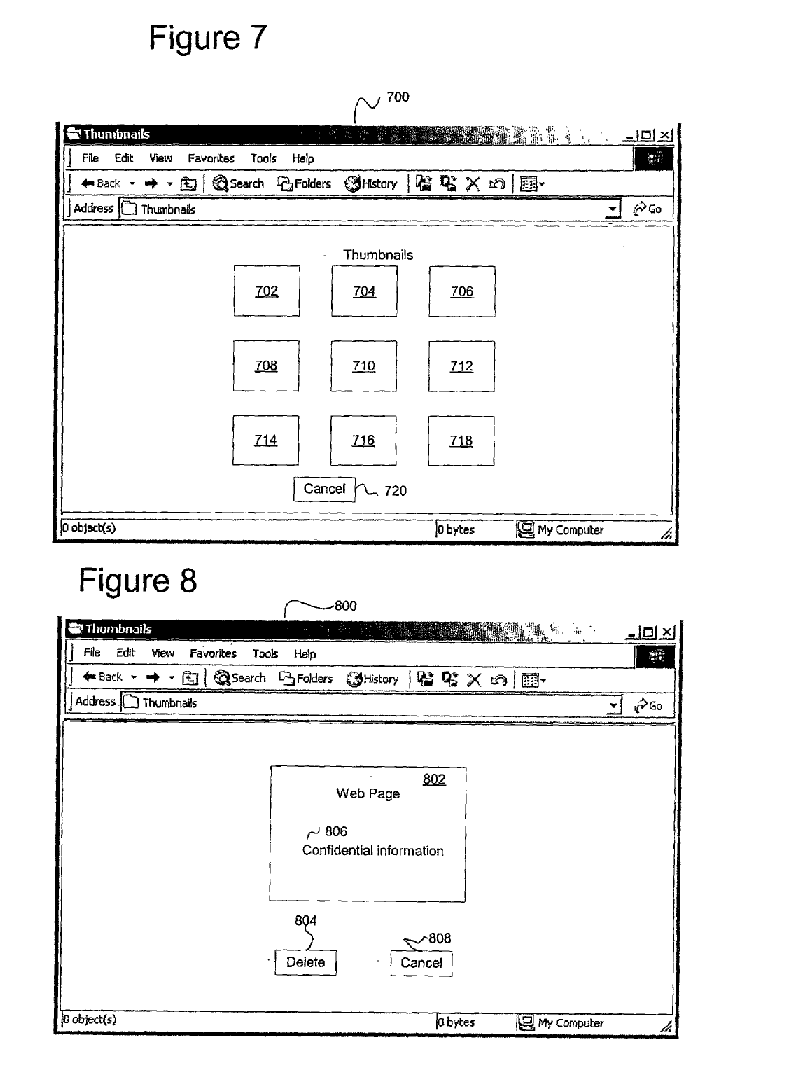

In this example, field 502 contains entries 504, 506, 508, and 510. Entry 504 is a phone number, entry 506 is a social security number, entry 508 is a birthday, and entry 510 is a password. These are strings of information that are removed from a history by the browser in these examples. Additional entries may be defined by selecting “Add” button 512. Entries may be removed by selecting an entry and “Delete” button 514. Additionally, multiple entries may be selected and deleted using “Delete” button 514. The selection of “Done” button 516 will result in a new version of the file being created. Selection of “Preview” button 518 results in a display of Web pages containing the confidential information, as described with respect to FIG. 7 below.

Turning next to FIG. 6, a diagram of a input window is depicted in accordance with a preferred embodiment of the present invention. Window 600 is an example of a window, which may be displayed in response to “Add” button 512 in FIG. 5. Information that is to be removed from a history may be defined or entered in field 602 by a user. The information is entered in the form of a string in these examples. Selection of “Okay” button 604 results in the entry being added to field 502 in FIG. 5. Selection of “Cancel” button 606 results in any input into field 602 being canceled and the closure of window 600.

With reference now to FIG. 7, a diagram of a preview of Web pages is depicted in accordance with a preferred embodiment of the present invention. Window 700 is generated in response to a selection of “Preview” button 518 in FIG. 5. In these examples, the preview presents thumbnails, such as thumbnails 702, 704, 706, 708, 710, 712, 714, 716, and 718. A thumbnail is a miniature representation of a Web page or image. A thumbnail may be generated by a thumbnail program. This program may be stand-alone or part of a desktop publishing or graphics program. Thumbnails provide a convenient way to browse through multiple images before retrieving the one you need. Programs often let a user click on the thumbnail to retrieve a full or larger representation of the Web page or image.

Selection of “Cancel” button 720 results in window 700 being closed. Selection of one of the thumbnails results in a Web page associated with the Web page being opened and presented for review as described below in FIG. 8.

Turning next to FIG. 8, a diagram of a Web page presented in a window is depicted in accordance with a preferred embodiment of the present invention. Window 800 is an example of a window presented in response to a selection of a thumbnail, such as those illustrated in FIG. 7. Web page 802 is presented within window 800. This Web page is associated with a thumbnail selected in window 700 in FIG. 7. In this example, confidential information 806 is located within Web page 802. Confidential information 806 may be, for example, a credit card number, a birth date, or a social security number. Selection of “Delete” button 804 results in confidential information 806 within Web page 802 being deleted or removed from the history while leaving the remainder of Web page 802 intact. Alternatively, the entire Web page may be deleted. Selection of “Cancel” button 808 results in the closing of window 800.

A similar type of window may be used to present other data structures that may contain confidential information, such as a cookie. In this instance, the cookie may be represented with a graphical representation or an icon rather than a thumbnail. Selection of this representation results in the information within the cookie being displayed to the user. Alternatively, the presentation of this information also may take the form of a tree in which the nodes of the tree represent Web pages or cookies. The selection of a node results in a representation of the Web page or cookie similar to that in FIG. 8.

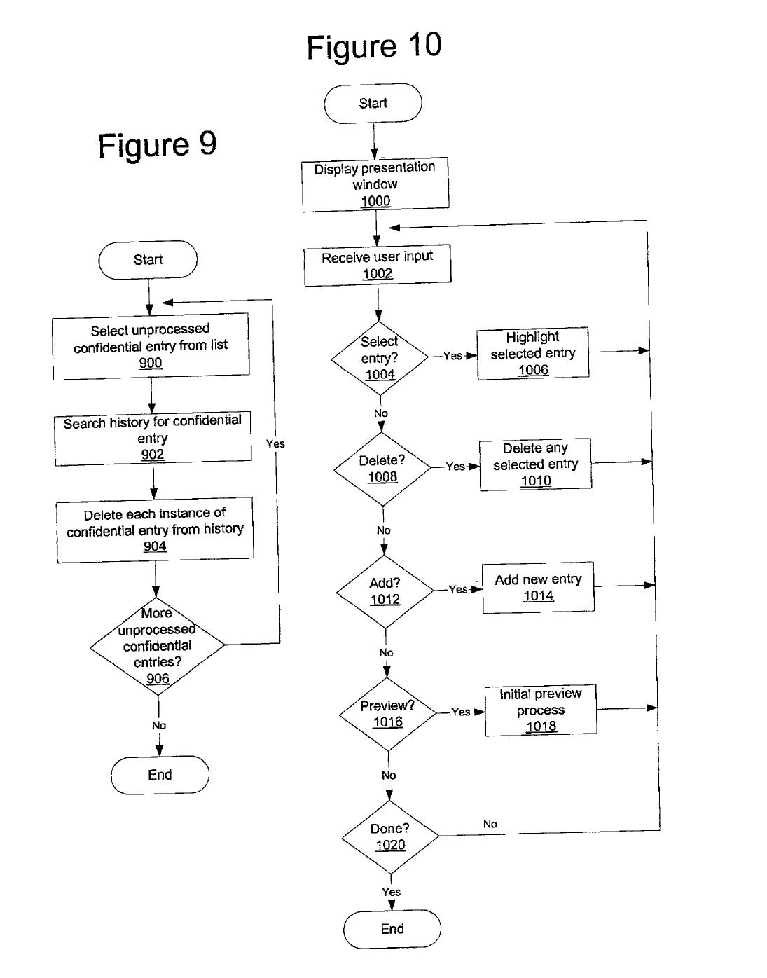

With reference now to FIG. 9, a flowchart of a process used for removing information from a history is depicted in accordance with a preferred embodiment of the present invention. The process illustrated in FIG. 9 may be implemented in a browser, such as browser 400 in FIG. 4.

The process begins by selecting an unprocessed confidential entry from a list (step 900). The list is one that is pre-defined or generated by a user in these examples. This list may be generated through a GUI, such as window 500 in FIG. 5. Next, a search is made for confidential information within the history matching the confidential entry from the list (step 902). Each instance of information matching a confidential entry is deleted from the history (step 904). A determination is then made as to whether more unprocessed confidential entries are present (step 906). If more unprocessed confidential entries are present, the process returns to step 900 as described above. Otherwise, the process terminates.

Turning next to FIG. 10, a flowchart of a process used for defining information for removal is depicted in accordance with a preferred embodiment of the present invention. The process illustrated in FIG. 10 may be implemented in a browser, such as browser 400 in FIG. 4. These processes are used in conjunction with a GUI, such as those illustrated in FIGS. 5-8.

The process begins by displaying a presentation window (step 1000). This presentation window may be, for example, window 500 in FIG. 5. Next, a user input is received (step 1002). This user input is typically made through a pointing device, such as, for example, a mouse, a trackball, a touchpad, a light pen, or a keyboard.

A determination is then made as to whether an entry has been selected by the user input (step 1004). If an entry has been selected, the selected entry is highlighted (step 1006) and the process returns to step 1002 as described above.

If an entry has not been selected by the user input, a determination is made as to whether the user input is a selection of a “Delete” button (step 1008). If the user input is a selection of a “Delete” button, any selected entries are deleted (step 1010) with the process returning the step 1002 as described above. Otherwise, a determination is made as to whether the user input is the selection of an “Add” button (step 1012). If the user input is the selection of an “Add” button, a new entry is added (step 1014) with the process returning to step 1002 as described above. The adding of the entry may take place using an interface, such as window 600 in FIG. 6.

If the user input is not the selection of the “Add” button, then a determination is made as to whether the user input is the selection of a “Preview” button (step 1016). If the user input is a selection of a “Preview” button, the preview process is initiated (step 1018) with the process returning to step 1002 as described above. The preview process is performed using window 700 in FIG. 7 and window 800 in FIG. 8.

Otherwise, a determination is made as to whether the user input is the selection of a “Done” button (step 1020). If the user input is the selection of a “Done” button, the process terminates. Otherwise, the process returns to step 1002 as described above.

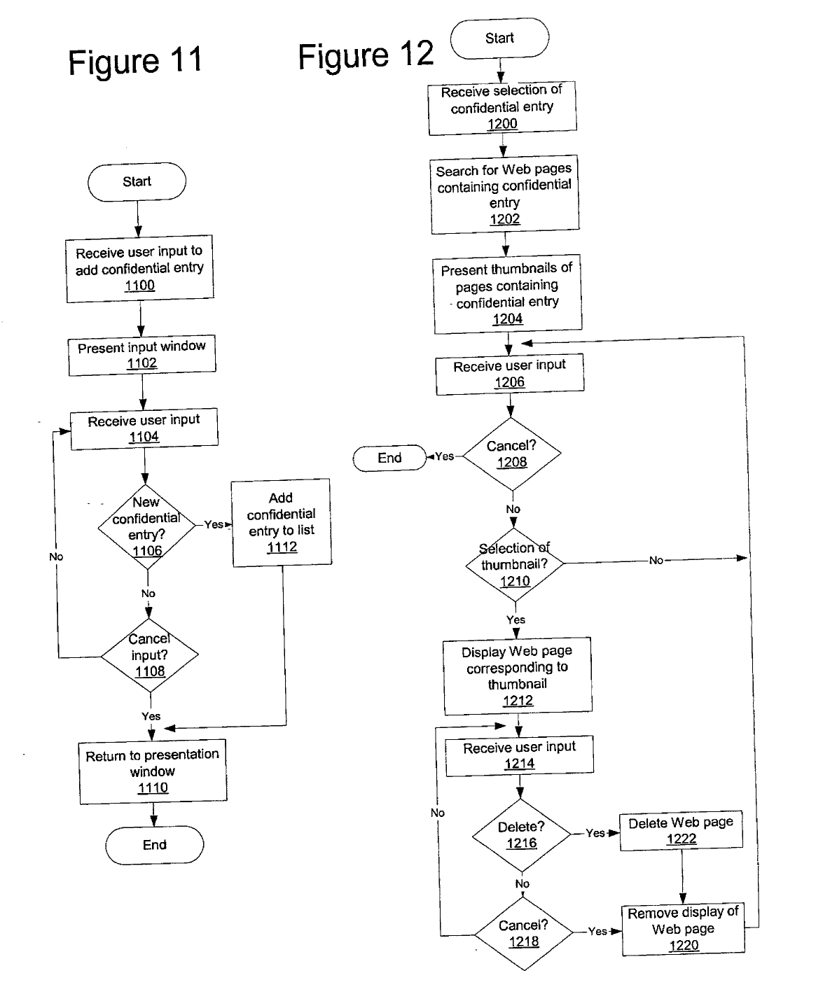

Turning next to FIG. 11, a flowchart of a process used for defining information for removal is depicted in accordance with a preferred embodiment of the present invention. The process illustrated in FIG. 11 may be implemented in a browser, such as browser 400 in FIG. 4.

The process begins by receiving a user input to add a confidential entry (step 1100). This user input may be the selection of a control, such as “Add” button 512 in FIG. 5. Next, the user is presented an input window (step 1102). This input window may be implemented using window 600 in FIG. 6. Thereafter, a user input is received (step 1104). A determination is made as to whether the user input is an entry of a new confidential entry (step 1106). A new confidential entry may be made in a field, such as field 602 in FIG. 6. If the user input is not the entry of a new confidential entry, a determination is made as to whether the user input is to cancel the procedure (step 1108). The procedure may be canceled using a control, such as “Cancel” button 606 in FIG. 6. If the user input is not to cancel the procedure, the process returns to step 1104 as described. Otherwise, the user is returned to the presentation window (step 1110) with the process terminating thereafter. The presentation window may be, for example, window 500 in FIG. 5.

Turning back to step 1106, if the user input is the selection of a new confidential entry, the confidential entry is added to the list (step 1112) and the process proceeds to step 1110 as described above.

With reference now to FIG. 12, a flowchart of a process used for previewing Web pages containing confidential information is depicted in accordance with a preferred embodiment of the present invention. The process illustrated in FIG. 12 may be implemented in a browser, such as browser 400 in FIG. 4. The process may be implemented using, window 500 in FIG. 5, window 700 in FIG. 7, and window 800 in FIG. 8.

The process begins by receiving a selection of a confidential entry (step 1200). This selection may be initiated through a selection of “Preview” button 518 in FIG. 5. Next, a search for Web pages containing the confidential entry is made (step 1202). Thumbnails of pages containing information matching the confidential entry are presented to the user (step 1204). A user input is then received (step 1206). A determination is then made as to whether the user input is the selection of a “Cancel” button (step 1208).

If the user input is the selection of a “Cancel” button, the process terminates. Otherwise, a determination is made as to whether the user input is the selection of a thumbnail (step 1210). If the user input is not the selection of a thumbnail, the process returns to step 1206 as described above. If the user input is the selection of a thumbnail, a Web page corresponding to the thumbnail is displayed to the user (step 1212).

Next, a second user input is received (step 1214). A determination is then made as to whether the second user input is the selection of a “Delete” button (step 1216). If the second user input is not the selection of a “Delete” button, a determination is made as to whether the second user input is the selection of a “Cancel” button. If the answer to this determination is no, the process returns to step 1214 as described above. If the second user input is the selection of a “Cancel” button, the display of the Web page is removed (step 1220) and the process returns to step 1206 as described above. With reference again to step 1216, if the second user input is the selection of a “Delete” button, the information within the Web page corresponding to the confidential entry is deleted (step 1222) with the process proceeding to step 1220 as described above.

A similar process may be used to preview or review information within a cookie file. Icons may be used to represent information with text information being displayed from a cookie in response to the selection of an icon.

It is important to note that while the present invention has been described in the context of a fully functioning data processing system, those of ordinary skill in the art will appreciate that the processes of the present invention are capable of being distributed in the form of a computer readable medium of instructions and a variety of forms and that the present invention applies equally regardless of the particular type of signal bearing media actually used to carry out the distribution. Examples of computer readable media include recordable-type media, such as a floppy disk, a hard disk drive, a RAM, CD-ROMs, DVD-ROMs, and transmission-type media, such as digital and analog communications links, wired or wireless communications links using transmission forms, such as, for example, radio frequency and light wave transmissions. The computer readable media may take the form of coded formats that are decoded for actual use in a particular data processing system.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A method in a data processing system for managing confidential information in a graphical user interface, the method comprising:
presenting confidential information within a history generated by a browser in the graphical user interface to form a presentation;
receiving a user input; and
manipulating the confidential information using the user input.

2. The method of claim 1 further comprising:
receiving a selection of the confidential information for presentation.

3. The method of claim 1, wherein the presentation is in a form of a set of thumbnails, wherein each thumbnail represents a Web page containing a portion of the confidential information.

4. The method of claim 3 further comprising:
responsive to a selection of a particular thumbnail from the set of thumbnails, displaying a Web page associated with the particular thumbnail.

5. The method of claim 1, wherein the presentation is in a form a of tree and wherein the confidential information presented as nodes in the tree.

6. The method of claim 5, wherein each node within the nodes represents an object containing a portion of the confidential information.

7. The method of claim 6, wherein the object includes at least one of a Web page and a cookie.

8. The method of clam 1, wherein the confidential information includes at least one of a phone number, a credit card number, a social security number, an address of a user, a user identification, a password, and a personal identification number.

9. The method of claim 2, wherein the receiving step comprises:
receiving the selection of information as a user input.

10. The method of claim 1, wherein the history includes a cookie file, a cache for storing data associated with Web pages, a location list, and a history list.

11. The method of claim 1, wherein the user input is to delete a selected portion of the confidential information.

12. The method of claim 11, wherein the selected portion is all of the confidential information.

13. A data processing system comprising:
a bus system;
a communications unit connected to the bus system;
a memory connected to the bus system, wherein the memory includes a set of instructions; and
a processing unit connected to the bus system, wherein the processing unit executes the set of instructions to present confidential information within a history generated by a browser in the graphical user interface to form a presentation; receive a user input; and manipulate the confidential information using the user input.

14. A data processing system for managing confidential information in a graphical user interface, the data processing system comprising:
presenting means for presenting confidential information within a history generated by a browser in the graphical user interface to form a presentation;
receiving means for receiving a user input; and
manipulating means for manipulating the confidential information using the user input.

15. The data processing system of claim 14, wherein the receiving means is a first receiving means and further comprising:
second receiving means for receiving a selection of the confidential information for presentation.

16. The data processing system of claim 14, wherein the presentation is in a form of a set of thumbnails, wherein each thumbnail represents a Web page containing a portion of the confidential information.

17. The data processing system of claim 16 further comprising:
displaying means for responsive to a selection of a particular thumbnail from the set of thumbnails, displaying a Web page associated with the particular thumbnail.

18. The data processing system of claim 14, wherein the presentation is in a form a of tree and wherein the confidential information presented as nodes in the tree.

19. The data processing system of claim 18, wherein each node within the nodes represents an object containing a portion of the confidential information.

20. The data processing system of claim 19, wherein the object includes at least one of a Web page and a cookie.

21. The data processing system of clam 14, wherein the confidential information includes at least one of a phone number, a credit card number, a social security number, an address of a user, a user identification, a password, and a personal identification number.

22. The data processing system of claim 15, wherein the second receiving means comprises:
means for receiving the selection of information as a user input.

23. The data processing system of claim 14, wherein the history includes a cookie file, a cache for storing data associated with Web pages, a location list, and a history list.

24. The data processing system of claim 14, wherein the user input is to delete a selected portion of the confidential information.

25. The data processing system of claim 24, wherein the selected portion is all for the confidential information.

26. A computer program product in a computer readable medium for managing confidential information in a graphical user interface, the computer program product comprising:
first instructions for presenting confidential information within a history generated by a browser in the graphical user interface to form a presentation;
second instructions for receiving a user input;
third instructions for manipulating the confidential information using the user input.
